(19) United States
(12) Patent Application Publication
(10) Pub. No.: US 2025/0249614 A1
(43) Pub. Date: Aug. 7, 2025

(54) CHUCK TABLE AND HALF-CUTTING METHOD

(71) Applicant: DISCO CORPORATION, Tokyo (JP)

(72) Inventors: Tomohiro KANEKO, Tokyo (JP); Masanori MISAIZU, Tokyo (JP); Hayato KIUCHI, Tokyo (JP); Mana ERITATE, Tokyo (JP); Shun UTAKA, Tokyo (JP); Yuya TANAKA, Tokyo (JP)

(73) Assignee: DISCO CORPORATION, Tokyo (JP)

(21) Appl. No.: 19/042,174

(22) Filed: Jan. 31, 2025

(30) Foreign Application Priority Data
Feb. 6, 2024 (JP) 2024-016126

(51) Int. Cl. B26D 3/06

(52) U.S. Cl. CPC B26D 3/06

(57) ABSTRACT

A chuck table is configured to suction and hold a plate-shaped workpiece on a holder surface. The chuck table includes a base having a holder surface region on an upper surface thereof, a plurality of suction holes which are arranged in the holder surface region, formed through to a lower surface of the base, and connectable with a suction source, and an elastic member made of an elastomer having a predetermined thickness. The elastic member is arranged entirely in the holder surface region and forms the holder surface.

### CROSS REFERENCE TO RELATED APPLICATION

This application is based upon and claims the benefit of priority from the prior Japanese Patent Application No. 2024-016126 filed on Feb. 6, 2024; the entire contents of which are incorporated herein by reference.

### FIELD

The present disclosure relates to a chuck table for holding a plate-shaped workpiece and a half-cutting method to cut the plate-shaped workpiece halfway.

### BACKGROUND

As disclosed in Japanese Patent Laid-Open Publications No. 2015-082627 and No. 2020-062722, for cut-machining a plate-shaped workpiece, a lower surface of the workpiece may be suctioned and held against a holder surface of a chuck table, and a cutter blade may cut into the workpiece from an upper side to create cut grooves (machined grooves). The cut-machining may include, for example, half-cutting, in which cut grooves with a depth smaller than a thickness of the workpiece are formed. Meanwhile, there may be cases where, due to warping of the workpiece, the lower surface of the workpiece may not entirely be in contact with the holder surface of the chuck table, and the workpiece may not be suctioned to be held securely against the holder surface.

### SUMMARY

In the state where the workpiece is not suctioned to be held against the holder surface of the chuck table securely, the workpiece may deviate during the process of cut-machining, and problems such as damages may be caused in the cutter blade.

Therefore, for a processing apparatus that may process a workpiece through, for example, cut-machining, a chuck table capable of suctioning and holding a warped workpiece by an entire lower surface of the workpiece is demanded.

In the meantime, when the warped workpiece is processed through cut-machining without consideration toward influences of the warped form in the workpiece, depths of the cut grooves formed in the cut-machining may vary undesirably.

Therefore, for cut-machining a warped workpiece, a cutting apparatus that may accurately form cut grooves having a depth that is smaller than a thickness of the workpiece is demanded.

According to an aspect of the present disclosure, a chuck table configured to suction and hold a plate-shaped workpiece on a holder surface includes a base having a holder surface region on an upper surface thereof, a plurality of suction holes arranged in the holder surface region and formed through to a lower surface of the base, the plurality of suction holes being connectable with a suction source, and an elastic member made of an elastomer having a predetermined thickness. The elastic member is arranged entirely in the holder surface region and forms the holder surface.

Optionally, a dynamic viscoelasticity of the elastic member when a temperature is between 20° C. and 30° C. may be greater than or equal to 0.1 tan δ and smaller than or equal to 0.4 tan δ.

Optionally, the elastic member may be formed of a thermoplastic elastomer or a foam elastomer.

The chuck table according to the present disclosure is advantageous in a case where the plate-shaped workpiece has bumps on a surface on one side thereof and is held by the chuck table with the bumps being in contact with the elastic member.

According to an aspect of the present disclosure, a half-cutting method, for forming a cut groove having a predetermined depth smaller than a thickness of the plate-shaped workpiece in the plate-shaped workpiece held by the chuck table with a cutter blade, includes a holding process for causing the chuck table to suction and hold the plate-shaped workpiece thereon, an upper-surface height measuring process for moving the plate-shaped workpiece held in the holding process in a cut-feeding direction and measuring heights of an upper surface of the plate-shaped workpiece at a plurality of positions along the cut-feeding direction with respect to the cutter blade, and a cutting process for forming the cut groove having the predetermined depth from the upper surface of the plate-shaped workpiece by moving the plate-shaped workpiece in the cut-feeding direction and lifting or lowering the cutter blade based on the heights of the upper surface measured in the upper-surface height measuring process.

According to the chuck table by the present disclosure, the elastic member made of the elastomer is arranged entirely over the holder surface of the base, thereby the lower surface of a warped workpiece may be entirely suctioned and held thereon.

According to the half-cutting method by the present disclosure, in the state where the lower surface of the warped workpiece is entirely suctioned and held against the chuck table, the workpiece is cut by the cutter blade which is lifted or lowered based on the heights of the upper surface at a plurality of positions measured in the upper-surface height measuring process. Thereby, cut grooves, of which depth is smaller than a depth of the workpiece, may be formed in the warped workpiece accurately.

### BRIEF DESCRIPTION OF THE DRAWINGS

FIG. 1 is a perspective view of a cutting apparatus having a chuck table.

FIG. 2 is a perspective view of the chuck table.

FIG. 3 is a cross-sectional view of the chuck table.

FIG. 4 illustrates a composition of a workpiece and a warped form of the workpiece.

FIG. 5 illustrates a composition of a workpiece and a warped form of the workpiece.

FIG. 6 is a cross-sectional view to illustrate an upper-surface height measuring process according to a half-cutting method.

FIG. 7 is a cross-sectional view to illustrate a cutting process according to the half-cutting method.

FIG. 8 is a perspective view of a chuck table in a modified example.

### DESCRIPTION OF EMBODIMENTS

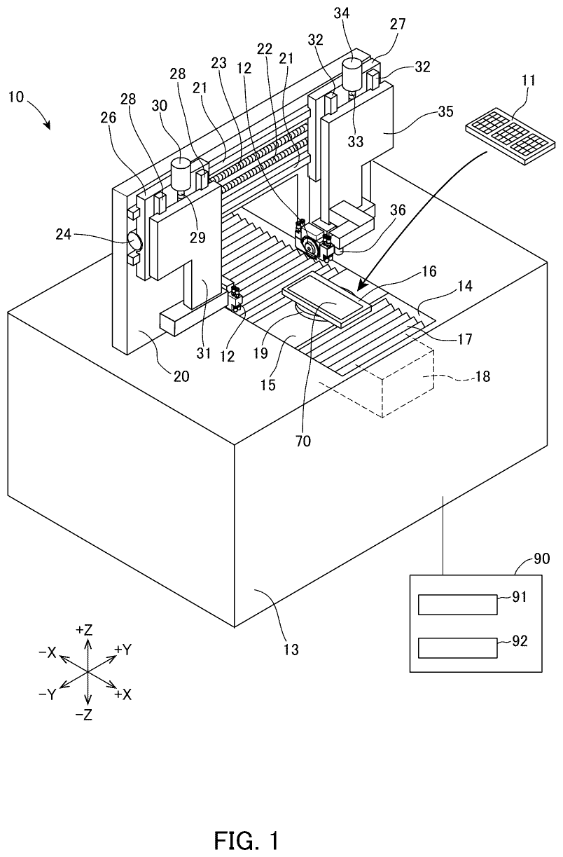

Hereinbelow, with reference to the accompanying drawings, a chuck table and a half-cutting method according to an embodiment of the present disclosure will be described. The present disclosure is embodied in a chuck table 16 provided to a cutting apparatus 10 as shown in FIG. 1. An X-axis direction and a Y-axis direction in the cutting apparatus 10 are horizontal direction, and the X-axis direction and the Y-axis direction are orthogonal to each other. A Z-axis direction is a vertical direction, where a +Z direction is an upward direction, and a −Z direction is a downward direction.

The cutting apparatus 10 is a processing apparatus that may cut and process a plate-shaped workpiece 11 (plate-shaped workpiece) being an object to be processed. The cutting apparatus 10 includes a pair of, i.e., two, cutting units 12, which are located to face each other in the Y-axis direction, and may cut and process the workpiece 11 with use of the cutting units 12. A quantity of the cutting units 12 is not limited to two but may optionally be one, three, or more.

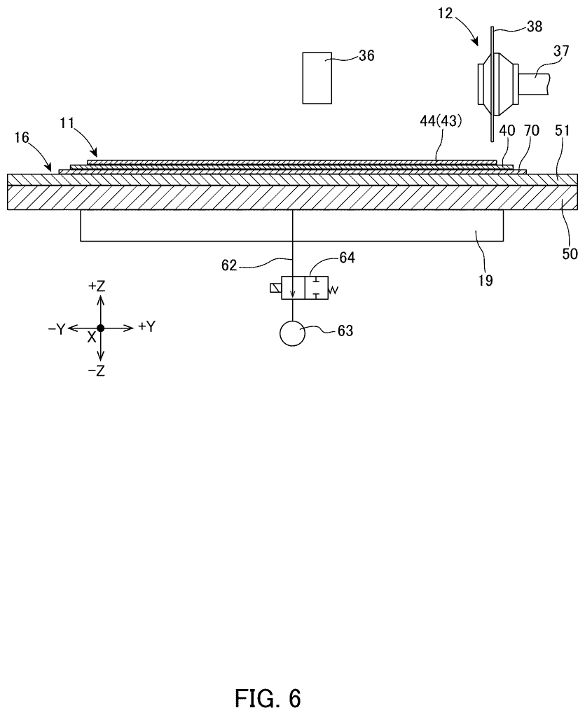

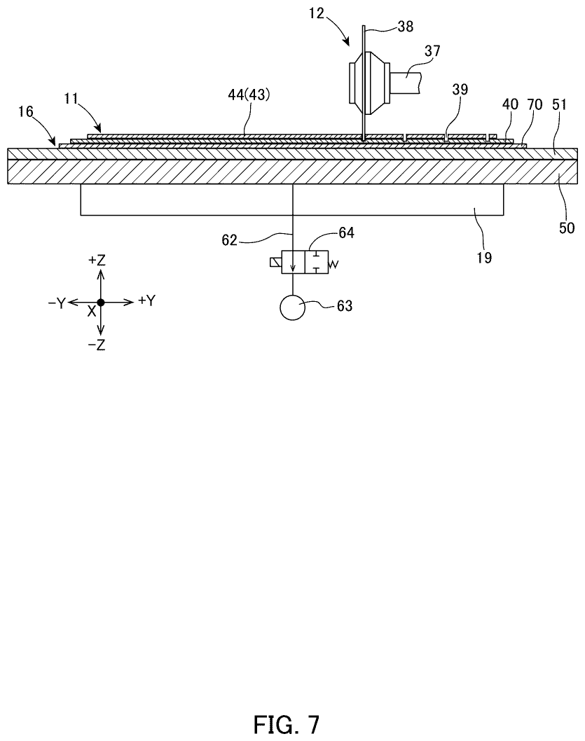

As shown in FIGS. 6 and 7, each cutting unit 12 is provided with a circular cutter blade 38 at a position toward a tip end of a spindle 37, which is a rotation shaft extending in the Y-axis direction. The spindle 37 may be rotated by a spindle motor, which is not shown, and the cutter blade 38 rotating along with the spindle 37 may cut into the workpiece 11 to process the workpiece 11.

The cutting apparatus 10 is controllable by a control unit 90. The control unit 90 includes a processor 91 (processor) that generates signals for controlling the components in the cutting apparatus 10 and a storage 92 (memory) for storing information to be used by the processor 91. The processor 91 may control acts of each component, which will be described further below, in the cutting apparatus 10 by reading and executing programs stored in the storage 92. Therefore, in the following description concerning the acts of the cutting apparatus 10, unless a subject of the controlling acts is specified, it is considered that the acts are performed under the control of the control unit 90.

On a base 13 of the cutting apparatus 10, an opening 14 elongated in the X-axis direction is formed. A movable board 15 is arranged inside the opening 14, and a chuck table 16 is arranged above the movable board 15. Bellows 17 are connected to both ends of the movable board 15 in the X-axis direction, and the movable board 15 and the bellows 17 are housed in the opening 14.

The chuck table 16 is a table to suction and hold the workpiece 11 there-onto when the workpiece 11 is cut and processed with use of the cutting units 12. The chuck table 16 will be described further below.

The movable board 15 and the chuck table 16 are movable in the X-axis direction by a table-feeder assembly 18 located below the movable board 15 inside the opening 14. The X-axis direction is a cut-feeding direction, in which the workpiece 11 held by the chuck table 16 may be moved with respect to the cutting units 12 while being cut and processed. The table-feeder assembly 18 includes a guide rail (not shown) and a ball screw (not shown), both extending in the X-axis direction, and a seat (not shown) supporting the chuck table 16 is movably supported by the guide rail to move in the X-axis direction. The ball screw is screwed to the seat, and as the ball screw is rotated by a motor (not shown), the seat may move in the X-axis direction.

Moreover, the chuck table 16 is rotatable with respect to the seat by a table-rotating assembly 19 about an axis extending in the Z-axis direction.

The chuck table 16 may be moved in the X-axis direction by the table-feeder assembly 18 to be located in a mount/demount region on a +X direction side or in a processing region on a −X direction side. In the mount/demount region, the workpiece 11 may be mount on or demounted from the chuck table 16. In the processing region, the chuck table 16 is located below the cutting units 12, where the workpiece 11 held on the chuck table 16 may be cut and processed by the cutting units 12.

On the base 13, a column 20 in a form of a gate saddled over the opening 14 in the Y-axis direction is provided. To a side of the column 20 in the +X direction, a pair of guide rails 21 extending in the Y-axis direction are attached. Between the pair of guide rails 21, a ball screw 22 and a ball screw 23, both extending in the Y-axis direction, are arranged. The ball screw 22 is driven by a motor 24 to rotate, and the ball screw 23 is driven by a motor (not shown) to rotate.

A Y-axis movable table 26 and a Y-axis movable table 27 are supported by the column 20 through the pair of guide rails 21 movably in the Y-axis direction. The ball screw 22 is screwed to a screw hole (not shown) formed in the Y-axis movable table 26, and as the ball screw 22 rotates, the Y-axis movable table 26 moves in the Y-axis direction. The ball screw 23 is screwed to a screw hole (not shown) formed in the Y-axis movable table 27, and as the ball screw 23 rotates, the Y-axis movable table 27 moves in the Y-axis direction.

On a sideward surface of the Y-axis movable table 26 on the +X direction side, a pair of guide rails 28 extending in the Z-axis direction are attached. At a position between the pair of guide rails 28, a ball screw 29 extending in the Z-axis direction is arranged. The ball screw 29 is driven by a motor 30 to rotate. A Z-axis movable table 31 is supported by the column 20 through the pair of guide rails 28 movably in the Z-axis direction. The ball screw 29 is screwed in a screw hole (not shown) formed in the Z-axis movable table 31, and as the ball screw 29 rotates, the Z-axis movable table 31 moves in the Z-axis direction.

On a sideward surface of the Y-axis movable table 27 on the +X direction side, a pair of guide rails 32 extending in the Z-axis direction are attached. At a position between the pair of guide rails 32, a ball screw 33 extending in the Z-axis direction is arranged. The ball screw 33 may be driven by a motor 34 to rotate. A Z-axis movable table 35 is supported by the column 20 through the pair of guide rails 32 movably in the Z-axis direction. The ball screw 33 is screwed in a screw hole (not shown) formed in the Z-axis movable table 35, and as the ball screw 33 rotates, the Z-axis movable table 35 moves in the Z-axis direction.

The Z-axis movable table 31 supports one of the cutting units 12 at a lower end thereof, and the Z-axis movable table 35 supports the other of the cutting units 12 at a lower end thereof. By moving the Y-axis movable table 26 in the Y-axis direction, a position of the one of the cutting units 12 changes in the Y-axis direction, and by moving the Z-axis movable table 31 in the Z-axis direction, the position of the one of the cutting units 12 changes in the Z-axis direction. By moving the Y-axis movable table 27 in the Y-axis direction, a position of the other of the cutting units 12 changes in the Y-axis direction, and by moving the Z-axis movable table 35 in the Z-axis direction, the position of the other of the cutting units 12 changes in the Z-axis direction. As such, each of the cutting units 12 is movable individually in the Y-axis direction and the Z-axis direction.

At a position in proximity to the one of the cutting units 12 located on the +Y direction side, an upper-surface height measuring device 36 is provided. The upper-surface height measuring device 36 is, along with the one of the cutting units 12, movable in the Y-axis direction and the Z-axis direction. Optionally, the upper-surface height measuring device 36 may be movable independently from the one of the cutting units 12.

The upper-surface height measuring device 36 is a height sensor that may measure a height of the workpiece 11 held on the chuck table 16 without contacting. For example, the height sensor may be an image capturing unit that may capture an image of an area below, and a height position of the workpiece 11 may be measured by capturing an image of the workpiece 11 with the image capturing unit and focusing the image capturing unit according to, for example, a contrast-detecting method. For another example, the height sensor may emit measuring light at the workpiece 11 and receive the light reflected off the upper surface of the workpiece 11, and based on the time between emitting and receiving of the light, the height sensor may measure the height position of the workpiece 11. For another example, furthermore, the height sensor may emit ultrasonic waves at the workpiece 11 and receive the waves reflected off the upper surface of the workpiece 11, and based on the time between emitting and receiving of the waves, the height sensor may measure the height position of the workpiece 11.

The workpiece 11 to be cut and processed in the cutting apparatus 10 may be, for example, a package substrate. The package substrate may be formed by mounting a device chip in each one of the plurality of device regions formed on a base board and sealing the device chips with a sealing member.

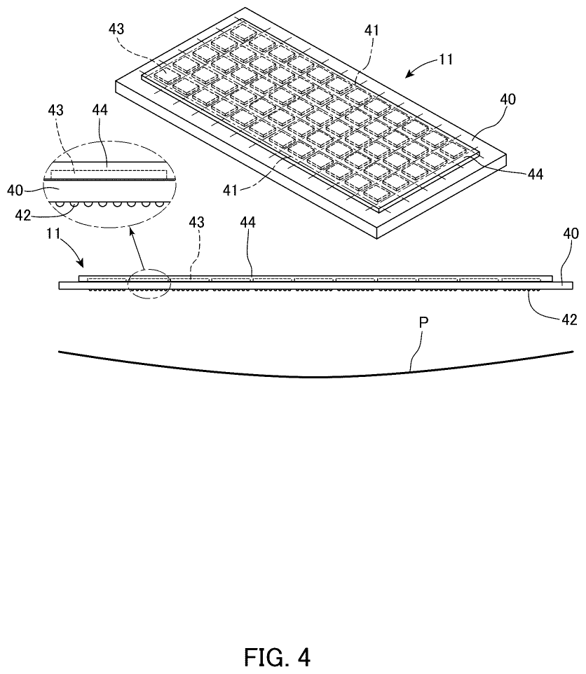

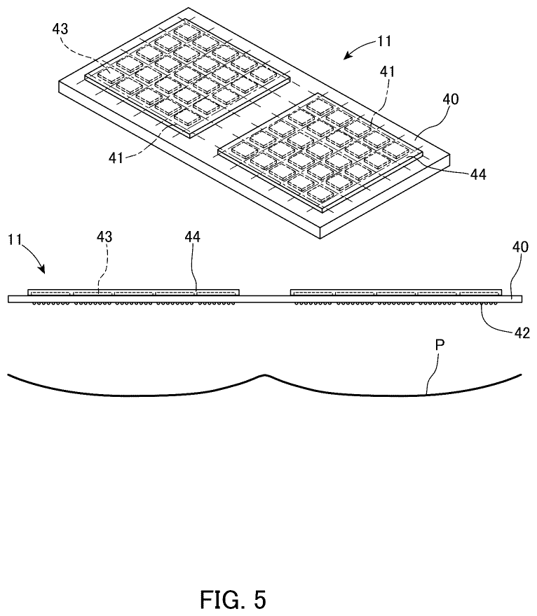

As shown in FIGS. 4 and 5, the workpiece 11 includes a substrate 40 in a rectangular form in a plan view, and the substrate 40 is provided with a plurality of device regions partitioned in grid with a plurality of divider lines 41. On a surface on one side of the substrate 40, bumps 42 formed of protrusive metal electrodes are provided at positions corresponding to respective ones of device regions. On a surface on the other side of the substrate 40, device chips 43 are provided at positions corresponding to respective ones of device regions. Each device chip 43 in each device region is connected to the bumps 42 arranged in the same device region. The plurality of device chips 43 are covered and sealed with a resin layer 44 (molding resin).

The workpiece 11 formed as above is prone to warp in the device regions where the device chips 43 are formed. FIG. 4 illustrates the workpiece 11, on an entire surface of which the device regions are continuously formed except an outer periphery thereof. FIG. 5 is another example of the workpiece 11, on which the device regions are provided in two separate blocks aligning in a lengthwise direction of the substrate 40.

FIGS. 4 and 5 each show the workpiece 11 viewed from an oblique and sideward view point and a warped form of the workpiece 11 represented in curve(s) P in a view from a side. It is noted that the curves P in FIGS. 4 and 5 are drawn in emphasized forms to illustrate the magnitude of the warpage in the workpiece 11 and may differ from the actual warpage of the workpiece 11. As shown in FIGS. 4 and 5, the workpiece 11 is convex on one side where the bumps 42 are formed and is concave on the other side where the device chips 43 are arranged. The forms of the workpieces 11 differ depending on the arrangement of the device regions on the respective workpieces 11.

The workpiece 11 may be placed on a holder surface of the chuck table 16 with the one side, on which the bumps 42 are formed, facing the holder surface to be suctioned and held against the chuck table 16. In other words, the workpiece 11 may be suctioned and held against the chuck table 16 with the one side, on which the bumps 42 are formed, facing downward.

For example, when the workpiece 11 is held on a holder surface of a conventional chuck table different from the chuck table 16 according to the present embodiment, the workpiece 11 may not be suctioned or held against the holder surface securely if the lower surface of the workpiece 11 is not in entirely contact with the holder surface of the chuck table. In particular, in the cases of the workpieces 11 warping in the forms as shown in FIGS. 4 and 5, the outer peripheries of the workpieces 11 may not fit to the holder surface of the chuck table but may be separated above from the holder surface, and the suctioning force may leak through the outer peripheries of the workpieces 11. Meanwhile, as shown in FIGS. 4 and 5, the workpieces 11 may deform to warp in various forms, and it is difficult to prepare chuck tables having various forms that may fit with the warped workpieces in the various forms. Furthermore, the uneven form of the lower surface of the workpiece 11 with the bumps 42 may also prevent the lower surface of the workpieces 11 from contacting the holder surface of the chuck table entirely.

Under the condition where the lower surface of the workpiece 11 is not suctioned or held against the holder surface of the chuck table entirely, the workpiece 11 may deviate from a correct position while being cut and processed, and the workpieces 11 may not be cur or processed accurately, or the cutter blades 38 in the cutting units 12 may be subjected to the excessive load that may be caused by the deviation of the workpiece 11 and may be damaged.

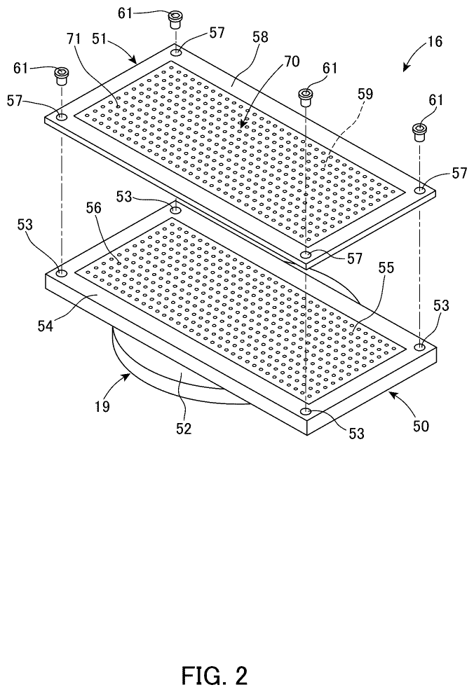

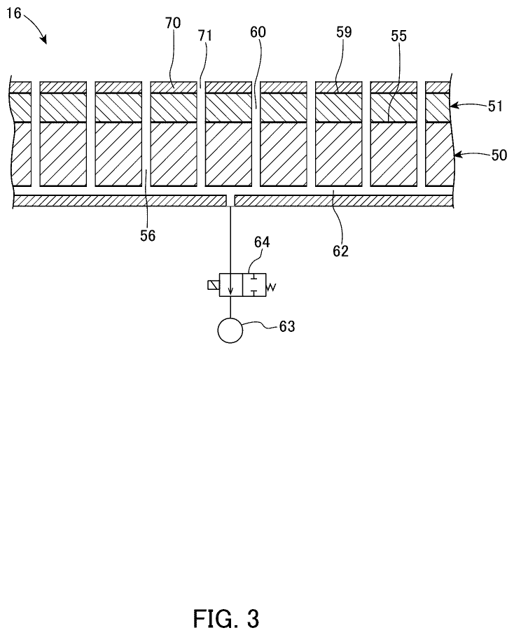

In order to prevent such problems, the chuck table 16 according to the present embodiment is enabled to suction and hold the entire lower surface of the warped workpiece 11. The chuck table 16 will be described below with reference to FIGS. 2 and 3.

The chuck table 16 includes a lower seat 50 and a base 51 which is detachably attached on top of the lower seat 50. The lower seat 50 is mounted on a rotary board 52 that composes the table-rotating assembly 19. As the table-rotating assembly 19 rotates the rotary board 52, the chuck table 16 rotates together with the rotary board 52.

The lower seat 50 is a plate member having a substantially rectangular form in a plan view. The lower seat 50 may be, for example, made of a metal such as stainless steel. At spots on four corners of the lower seat 50, four screw holes 53 are formed. In an outer peripheral region 54 in a form of a frame located toward outer edges of the lower seat 50, no hole other than the screw holes 53 is formed, and an upper surface of the outer peripheral region 54 is formed to be flat except for the spots where the screw holes 53 are formed. In an inner region 55 enclosed by the outer peripheral region 54, a plurality of suction holes 56 are formed at predetermined intervals. As shown in FIG. 3, the suction holes 56 are open upward, and lower ends of the suction holes 56 are connected with a suction path 62.

The outer peripheral region 54 and the inner region 55 are provided for a purpose to conceptually represent a region where the suction holes 56 are formed and a region where no suction hole is formed, and a clear boundary between the outer peripheral region 54 and the inner region 55 may not necessary be provided. Meanwhile, optionally, in order to prevent leakage of the air through a gap between a plurality of suction holes 60 formed in the base 51, which will be described further below, and the suction holes 56, the inner region 55 may be formed to protrude upward with respect to the outer peripheral region 54 so that the inner region 55 may be arranged to securely and closely fit to the base 51.

The base 51 is a plate member having a substantially rectangular form in a plan view in a substantially same dimensions as the lower seat 50. The base 51 may be made of, for example, a metal such as stainless steel. At spots on four corners of the base 51, four through holes 57 are formed. The four through holes 57 are in a positional relationship corresponding to the four screw holes 53 in the lower seat 50. In an outer peripheral region 58 in a form of a frame located toward outer edges of the base 51, no hole other than the through holes 57 is formed, and an upper surface of the outer peripheral region 58 is formed to be flat except for the spots where the through holes 57 are formed. An inner region enclosed by the outer peripheral region 58 forms a holder surface region 59. In the holder surface region 59, the plurality of suction holes 60 are formed at predetermined intervals (see FIG. 3). The plurality of suction holes 60 are arranged in a positional relationship corresponding to the plurality of suction holes 56 in the lower seat 50. Each of the suction holes 60 is formed through the base 51 in the vertical direction (Z-axis direction) and open on the upper surface and the lower surface of the base 51.

When assembling the chuck table 16, the base 51 is layered on top of the lower seat 50 with the lower surface facing downward and with the four through holes 57 located to coincide with the four screw holes 53. Fixing screws 61 are inserted in the respective through holes 57 and rotated to be screwed to the screw holes 53. When the fixing screws 61 are tightened with a predetermined torque, the base 51 is fixed to the lower seat 50. When the fixing screws 61 are rotated in the opposite direction to the tightening direction, the base 51 is released from the lower seat 50 and removed.

As shown in FIG. 3, in the state where the base 51 is fixed to the lower seat 50 by the fixing screws 61, the suction holes 60 formed in the base 51 are continuous with the suction holes 60 formed in the lower seat 50.

The chuck table 16 further includes an elastic member 70 made of an elastomer having a predetermined thickness laid entirely over the holder surface region 59 of the base 51. As such, the holder surface of the chuck table 16 is formed of the elastic member 70. The elastic member 70 has a substantial area for holding the entire lower surface of the workpiece 11 thereon. The elastic member 70 has a plurality of suction holes 71 formed at predetermined intervals. The plurality of suction holes 71 are arranged in a positional relationship corresponding to the plurality of suction holes 60 in the base 51.

As shown in FIG. 3, the plurality of suction holes 71 are formed through the elastic member 70 in the vertical direction (Z-axis direction) and open on an upper surface and a lower surface of the elastic member 70. The suction holes 71 are continuous with the respective suction holes 60 in the base 51, and the suction holes 60 are continuous with the respective suction holes 56 in the lower seat 50. As such, the lower seat 50, the base 51, and the elastic member 70 are layered in a positional relationship where the suction holes 56, the suction holes 60, and the suction holes 71 respectively communicate with one another in the vertical direction.

As shown in FIG. 3, the suction holes 56 are connected to a suction source 63 through the suction path 62. At an intermediate position in the suction path 62, an open/close valve 64 is provided, and the open/close valve 64 may be switched between an open state, in which the open/close valve 64 is open to connect the suction holes 56, 60, 71 with the suction source 63, and a closed state, in which the open/close valve 64 disconnects the suction holes 56, 60, 71 from the suction source 63. When the open/close valve 64 is in the open state, the suction source 63 may be activated, suctioning the air through the suction holes 56, 60, 71 to generate negative pressure on an upper side of the elastic member 70 and causing a suctioning force to act on the holder surface formed of the elastic member 70.

For holding the workpiece 11 on the chuck table 16, the open/close valve 64 is opened, the suction source 63 is activated, the suctioning force is caused to act on the upper surface of the elastic member 70, and the workpiece 11 is placed on the upper surface of the elastic member 70 with the lower surface thereof facing downward. Accordingly, the lower surface of the workpiece 11 suctioned fits tightly to the elastic member 70 and may be held against the upper surface of the chuck table 16. Meanwhile, the bumps 42 protruding downward from the lower surface of the workpiece 11 contact the elastic member 70.

The elastic member 70 is formed of a low-resilience flexible material that has a superior conformability with the warp and the unevenness of the lower surface of the workpiece 11. Therefore, in a case where the workpiece 11 is warped or where the lower surface of the workpiece 11 is uneven with, for example, the bumps 42, the elastic member 70 may fit tightly to the entire lower surface of the workpiece 11.

More specifically, it is desirable that the elastic member 70 has a dynamic viscoelasticity greater than or equal to 0.1 tan δ and smaller than or equal to 0.4 tan δ when the temperature is between 20° C. and 30° C. The dynamic viscoelasticity was measured through an experiment by applying periodic vibration or deformation to the material of the elastic member 70 and measuring elasticity and viscosity thereof as a function of temperature from the stress against the vibration or the deformation.

The result of the experiment shows that, when the dynamic viscoelasticity of the elastic member 70 satisfies the above condition, the elastic member 70 exhibits preferable conformability with the warp in the workpieces 11 and is able to fit tightly to the entire lower surface of the warped workpiece 11. Moreover, when the dynamic viscoelasticity of the elastic member 70 satisfies the above condition, the elastic member 70 is able to fit tightly to the entire lower surface of the workpiece 11 that has not only the warp but also the bumps 42. On the other hand, when the dynamic viscoelasticity of the elastic member 70 falls far outside the above condition range, there is a concern that the elastic member 70 may not fit entirely to the lower surface of the warped workpiece 11.

Moreover, it is preferable that a thickness of the elastic member 70 is within a range between 0.1 mm and 1 mm. The result of the experiment shows that, when the thickness of the elastic member 70 is within this range, the elastic member 70 is able to fit tightly to the entire lower surface of the workpiece 11 that has warps or the unevenness. When the thickness of the elastic member 70 is smaller than the above range, it may be difficult for the elastic member 70 to closely conform with the warp in the workpiece 11 or the unevenness of the lower surface of the workpiece 11. When the thickness of the elastic member 70 is greater than the above range, stability of the workpiece 11 to be held on the chuck table 16 may be lowered, or it may be difficult to maintain positioning or postural accuracy of the workpiece 11 on the chuck table 16. The elastic member 70 according to the present embodiment is made of a thermoplastic elastomer. This thermoplastic elastomer is in a form of liquid or paste at a room temperature but is hardened while retaining its flexibility by being heated to a predetermined temperature. For forming the elastic member 70 in the chuck table 16, the thermoplastic elastomer in the form of liquid or paste is applied to the holder surface region 59 in the base 51, the applied thermoplastic elastomer is heated to the predetermined hardening temperature, and thereby the elastic member 70 that satisfies the above dynamic viscoelasticity is formed.

Before the thermoplastic elastomer applied to the base 51 is heated or hardened, the open/close valve 64 is opened, and the suction source 63 is activated. Accordingly, the thermoplastic elastomer is suctioned at spots corresponding to the suction holes 56 and the suction holes 60, and the suction holes 71 are formed in the thermoplastic elastomer applied to the base 51. Thereafter, the thermoplastic elastomer is heated, and thereby the elastic member 70 having the plurality of suction holes 71 is completed. According to this manufacturing method, the large number of suction holes 71 may be formed easily and accurately at the positions corresponding to the suction holes 56 and the suction holes 60 without using complicated equipment or performing burdensome perforating works, and productivity of the chuck table 16 may be improved.

Optionally, the elastic member 70 may be formed of a material other than thermoplastic elastomer. For example, the elastic member 70 may be formed of a material that may harden in response to an external stimulus, such as humidity change, exposure to ultraviolet light, or exposure to light having a specific wavelength, while retaining flexibility.

Moreover, a method to form the elastic member 70 is not limited to the method described above. For example, the elastic member 70 may be formed in the chuck table 16 by preparing a sheet-formed elastic member 70, in which the suction holes 71 are formed in advance, and adhering the elastic member 70 to the holder surface region 59 in the base 51.

Hereinbelow, acts of the cutting apparatus 10 having the chuck table 16 configured as above and a half-cutting method to be applied to the workpiece 11 with use of the cutting apparatus 10 will be described.

[Holding Process]

A holding process, through which the plate-shaped workpiece 11 is suctioned and held against the chuck table 16, is performed. First, as shown in FIG. 1, while the chuck table 16 is located in the mount/demount region, the workpiece 11 is placed on the elastic member 70 of the chuck table 16. The workpiece 11 is placed on the elastic member 70 with the one side, on which the bumps 42 are formed, facing downward and the other side, on which the device chips 43 and the resin layer 44 are formed, facing upward (see FIG. 6).

The control unit 90 opens the open/close valve 64 and activates the suction source 63 to cause the suctioning force to act on the upper surface of the elastic member 70. By this suction force, the workpiece 11 is suctioned and held against the upper surface of the elastic member 70. With the workpiece 11 suctioned and held against the elastic member 70, the table-feeder assembly 18 moves the chuck table 16 from the mount/demount region to the processing region.

The control unit 90 sets an orientation of the chuck table 16 in the rotating direction through the table-rotating assembly 19 so that the divider lines 41 in the form of grid on the workpiece 11 extend in the X-axis direction and the Y-axis direction. In the present embodiment, first, the chuck table 16 is set to an orientation, in which the lengthwise direction of the rectangular-shaped workpiece 11 and the chuck table 16 coincides with the X-axis direction.

### [Upper-Surface Height Measuring Process]

Next to the holding process, the chuck table 16 is located in the processing region, and with the workpiece 11 being suctioned and held against the upper surface of the elastic member 70, an upper-surface height measuring process as shown in FIG. 6 is performed. In the upper-surface height measuring process, under the control by the control unit 90, a height of the workpiece 11 held on the chuck table 16 is measured with use of the upper-surface height measuring device 36. As described above, the upper-surface height measuring device 36 is a height sensor that may measure the height of the workpiece 11 held on the chuck table 16 in a contactless method such as focusing the image-capturing device to the workpiece 11, emitting and receiving measuring light, or emitting and receiving ultrasonic waves.

The control unit 90 controls the ball screw 23 to rotate and controls the Y-axis movable table 27 and the Z-axis movable table 35 supporting the upper-surface height measuring device 36 to move in the Y-axis direction to locate the Y-axis movable table 27 and the Z-axis movable table 35 above the workpiece 11. Next, the control unit 90 controls the table-feeder assembly 18 to move the chuck table 16 in the X-axis direction, which is the cut-feeding direction to move the workpiece 11 with respect to the cutter blades 38, and while the workpiece 11 passes below the upper-surface height measuring device 36, the control unit 90 measures the height of the workpiece 11 entirely throughout the range of the workpiece 11 in the X-axis direction (the lengthwise direction of the workpiece 11) with the upper-surface height measuring device 36.

In the upper-surface height measuring process, an upper surface height of the workpiece 11 is measured at a plurality of positions along the X-axis direction, which is the cut-feeding direction with respect to the cutter blades 38. In particular, based on values from an encoder, which detects a driving amount of the motor in the table-feeder assembly 18, and information of the heights of the workpiece 11 measured at the plurality of positions in the X-axis direction by the upper-surface height measuring device 36, upper-surface height data including information of height (change information of the height) in the Z-axis direction of the entire workpiece 11 in the X-axis direction is obtained. The obtained upper-surface height data is stored in the storage 92 in the control unit 90.

For regions between the plurality of positions at which the upper-surface height measuring device 36 measured the upper-surface height of the workpiece 11, the control unit 90 may calculate tendencies of changes in the upper-surface heights of the workpiece 11 based on the relationship among the upper-surface heights at the measured positions and obtain complementary upper-surface height data. Therefore, in the upper-surface height measuring process, the larger the number of positions in the X-axis direction at which the upper-surface height of the workpiece 11 is measured, and the narrower the interval between the measured positions is, the more finely (accurately) the upper-surface height data obtained by the measurement corresponds to the actual form of the upper surface of the workpiece 11. The number and the intervals of the positions at which the height of the upper surface of the workpiece 11 is to be measured may be determined optionally in consideration of balance among the burden and the time that may be caused or required by the processes for measuring and calculating and the accuracy of the upper-surface height data.

For example, for obtaining the upper-surface data which is as accurate as possible, the upper-surface height of the workpiece 11 may be measured continuously (at a plurality of consecutive height measuring positions) throughout the range of the workpiece 11 in the X-axis direction.

The intervals between the plurality of positions in the X-axis direction to measure the upper-surface height of the workpiece 11 may either be equal or different. For example, when tendencies of the workpiece 11 to warp is predictable in advance based on information of, for example, the arrangement of the device chips 43 and the resin layer 44, the upper-surface height of the workpiece 11 may be measured in an increased density (by narrowing the intervals between the positions where the upper-surface height is measured) in a particular area where the workpiece 11 is predicted to warp more largely.

[Cutting Process]

Next to the upper-surface measuring process, the cutting process as shown in FIG. 7 is performed. In the cutting process, the workpiece 11 being suctioned and held against the upper surface of the elastic member 70 is cut by the cutting units 12. Although solely one cutting unit 12 is shown in FIG. 7, cutting may be performed simultaneously at the two locations by using both of the paired cutting units 12.

For cutting the workpiece 11, the control unit 90 controls the ball screws 22, 23 to rotate to move the Y-axis movable tables 26, 27 in the Y-axis direction and locate the cutter blades 38 in the cutting units 12 to positions above the aimed ones of the divider lines 41. Next, the control unit 90 controls spindle motors (not shown) provided to each of the cutting units 12 to rotate the spindles 37 and the cutter blades 38 and controls the ball screws 29, 33 to rotate to lower the Z-axis movable tables 31, 35 and controls the rotating cutter blades 38 to cut into the upper surface of the workpiece 11. Furthermore, the control unit 90 controls the table-feeder assembly 18 to move the chuck table 16 (feed for processing), and the cutter blades 38 cut and process the workpiece 11 to form cut grooves 39 in the workpiece 11. According to the present embodiment, the cut-processing is in a half-cutting style, in which each cutter blade 38 cuts into a halfway of the thickness of the substrate 40 to form the cut groove 39 having a bottom with a depth which is smaller than the thickness of the workpiece 11.

In the cutting process, based on the upper-surface height data (the upper-surface heights measured at the plurality of positions in the measuring process) obtained and stored in the storage 92 in the upper-surface height measuring process, the control unit 90 occasionally controls the devices and the assemblies to adjust the cutting depths of the cutter blades 38 from the upper surface of the workpiece 11 so that the cut grooves 39 are formed to have a predetermined depth from the upper surface of the workpiece 11. In particular, the control unit 90 controls the table-feeder assembly 18 to move the workpiece 11 in the X-axis direction and controls the position of the cutting units 12 in the Z-axis direction to lift or lower the cutter blades 38 so that the cutting depths of the cutter blades 38 from the upper surface of the workpiece 11 may be constant throughout the length of the cut grooves 39 entirely in the X-axis direction. For example, when the workpiece 11 is warped in the curve P as shown in FIG. 4, the upper-surface height data corresponding to the warped form of the workpiece 11 is stored in the storage 92. In other words, according to the upper-surface data stored in the storage 92, the upper surface of the workpiece 11 is highest at the both ends in the X-axis direction (lengthwise direction) and gradually descends toward a center of the workpiece 11 in the X-axis direction. As the workpiece 11 is being cut, the control unit 90 controls the rotating acts of the ball screws 29, 33 in conjunction with the movement of the table-feeder assembly 18 feeding the workpiece 11 in the X-axis direction and adjusts the heights of the cutter blades 38 by lifting or lowering so that the cutting depths may be adjusted in accordance with the change of the height of the upper surface of the workpiece 11 stored in the storage 92. As such, by controlling and adjusting the cutting depths of the cutter blades 38, the warped workpiece 11 may be cut and processed accurately without deviation of the cutting depths so that the respective cut grooves 39 are formed to have a predetermined depth from the upper surface of the workpiece 11.

Moreover, as the chuck table 16 with the elastic member 70 suctions and holds the entire lower surface of the workpiece 11 thereon, the workpiece 11 may be prevented from deviating on the chuck table 16 while being cut-processed. Without deviating on the chuck table 16, the workpiece 11 may be cut along the divider lines 41 accurately, eliminating the risk of erroneously cutting, for example, the device chips 43 located apart from the divider lines 41. Furthermore, the workpiece 11 may not have a spot where the workpiece 11 is unstably separated above from the elastic member 70 of the chuck table 16; therefore, the workpiece 11 may be secured to stay without vibrating when the cutter blades 38 cut into the workpiece 11. Therefore, the cutter blades 38 may be prevented from being damaged by excessive load that may otherwise act thereon.

When the process to cut the workpiece 11 along the divider lines 41 is completed, the control unit 90 controls the ball screws 29, 33 to rotate to lift and separate the cutting units 12 from the workpiece 11, controls the ball screws 22, 23 to rotate to move the cutting units 12 in the Y-axis direction and locate the cutter blades 38 in the cutting units 12 to positions above the next ones of the divider lines 41 to be cut. Thereafter, in the same manner as described above, the workpiece 11 is processed to form the cut grooves 39 by cutting along the divider lines 41 with the cutter blades 38.

When cutting along all of the divider lines 41 extending in the lengthwise direction of the workpiece 11 is completed, the control unit 90 proceeds to a process of cutting the divider lines 41 extending in the widthwise direction of the workpiece 11. The control unit 90 controls the table-rotating assembly 19 to rotate the chuck table 16 by 90 degrees. By this rotation, the multiple divider lines 41 extending in the widthwise direction of the workpiece 11 that are not yet cut are set to extend in the X-axis direction.

The cutting process to cut the workpiece 11 along the divider lines 41 extending in the widthwise direction is substantially the same as the cutting process to cut the workpiece 11 along the divider lines 41 extending in the lengthwise direction; therefore, the process will be described briefly below.

By the time when the chuck table 16 is to be rotated by 90 degrees, the workpiece 11 is in the state where the workpiece 11 is suctioned and held against the chuck table 16 (having been through the holding process), and the control unit 90 conducts the upper-surface height measuring process with the rotated chuck table 16. In the upper-surface height measuring process, the control unit 90 controls the table-feeder assembly 18 to move the chuck table 16 in the X-axis direction and controls the upper-surface height measuring device 36 to measure the height of the upper surface of the workpiece 11 at a plurality of positions along the X-axis direction in an entire range of the workpiece 11 in the X-axis direction (widthwise direction). The upper-surface height data of the workpiece 11 obtained through the measurement is stored in the storage 92 in the control unit 90.

Next, the cutting process is performed. In the cutting process, the control unit 90 locates the cutter blades 38 of the cutting units 12 at positions above the divider lines 41 extending in the X-axis direction (widthwise direction) of the workpiece 11, lowers the rotating cutter blades 38 to cut into the upper surface of the workpiece 11, and controls the table-feeder assembly 18 to move the chuck table 16 in the X-axis direction to form the cut grooves 39 along the divider lines 41.

For cut-processing the workpiece 11, the control unit 90 controls lifting/lowering of the cutter blades 38 to adjust the cutting depths of the cutter blades 38 (positions of the cutting units 12 in the Z-axis direction) based on the upper-surface height of the workpiece 11 in order to maintain the depths of the cut grooves 39 constant so that the cut grooves 39 having the predetermined depth from the upper surface of the workpiece 11 may be formed.

When the cut-processing along the divider lines 41 is completed, the control unit 90 locates the cutter blades 38 in the cutting units 12 above another ones of the divider lines 41 that are aimed to be cut next and cuts the workpiece 11 along the next divider lines 41 with the cutter blades 38. When the cut-processing with the workpiece 11 along all of the divider lines 41 extending in the widthwise direction is completed, the cutting process is completed.

In the similar manner as the manner to form the cut grooves 39 by cut-processing in the lengthwise direction of the workpiece 11, for forming the cut grooves 39 by cut-processing in the widthwise direction of the workpiece 11, the elastic member 70 of the chuck table 16 suctions and holds the entire lower surface of the workpiece 11 thereon; therefore, the workpiece 11 may be prevented from deviating on the chuck table 16. As such, the cutter blades 38 may be prevented from being damaged while cutting the workpiece 11 to form the cut grooves 39 along the divider lines 41 accurately.

In the present embodiment, the measuring process and the cutting process are performed with the workpiece 11, first in the orientation where the lengthwise direction of the workpiece 11 coincides with the X-axis direction, and thereafter, the measuring process and the cutting process are performed with the workpiece 11 in the orientation where the widthwise direction of the workpiece 11 coincides with the X-axis direction. However, the upper-surface height measuring process may be performed consecutively along the lengthwise direction and the widthwise direction of the workpiece 11 (in other words, to the entire upper surface of the workpiece 11), and thereafter, the cutting process to cut along the entire divider lines 41 may be performed for the upper surface of the workpiece 11 without performing the intervening upper-surface height measuring process.

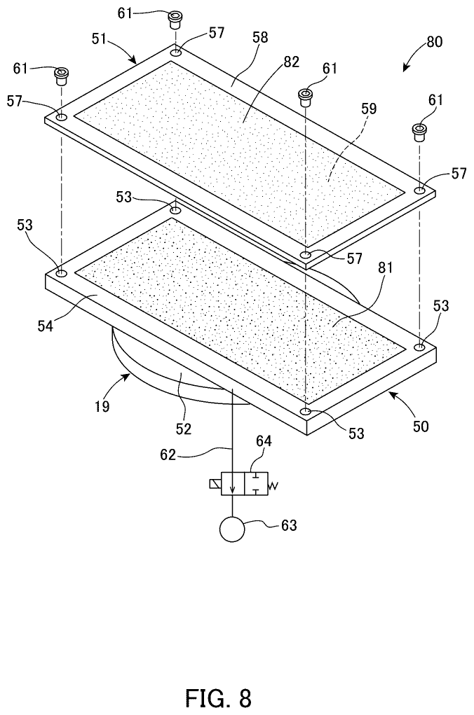

FIG. 8 illustrates a chuck table 80 being a modified example of the chuck table according to the present disclosure. With regard to the chuck table 80 being the modified example, items that are common with those in the chuck table 16 in the above embodiment will be referred to by the same signs, and explanation of those will be omitted.

In the inner region 55 (see FIG. 2) on the lower seat 50 of the chuck table 80, a porous sheet 81 formed of, for example, porous ceramics having a plurality of pores is provided. The porous sheet 81 is connected to the suction source 63 through the suction path 62, and the suction path 62 is provided with the open/close valve 64.

In the holder surface region 59 on the base 51 of the chuck table 80, an elastic member 82 formed of an elastomer having a predetermined thickness is provided. The elastic member 82 is made of foamed elastomer having pores and is, similarly to the elastic member 70, a low-resilient flexible member having preferable conformability with the workpiece 11. By attaching the foam elastomer in the form of sheet on the holder surface region 59 of the base 51, the elastic member 82 is formed.

Although not shown in FIG. 8, the plurality of suction holes 60 (see FIG. 3) are formed through the base 51 in the vertical direction (Z-axis direction). Upper ends of the suction holes 60 are located at positions where the base 51 is connected to a lower surface of the elastic member 82, and lower ends of the suction holes 60 are located at positions where the base 51 is connected to an upper surface of the porous sheet 81.

As the open/close valve 64 is opened and the suction source 63 is activated, the air is suctioned through the pores in the porous sheet 81, the suction holes 60, and the pores in the elastic member 82, and the suctioning force acts on the holder surface of the chuck table 80 composed of the elastic member 82. Accordingly, the entire lower surface of the workpiece 11 may be suctioned and held against the holder surface of the chuck table 80.

It is desirable that, similarly to the elastic member 70 in the embodiment described above, the elastic member 82 has a dynamic viscoelasticity greater than or equal to 0.1 tan δ and smaller than or equal to 0.4 tan δ when the temperature is between 20° C. and 30° C., and the thickness of the elastic member 82 is within a range between 0.1 mm and 1 mm.

The chuck table 80 in the configuration as above has the elastic member 82 formed of an elastomer with a predetermined thickness arranged in the entire holder surface region 59 in the base 51, and thereby, similarly to the chuck table 16 in the embodiment described above, the elastic member 82 may fit tightly to the entire lower surface of the warped workpiece 11 or the entire lower surface of the workpiece 11 which is uneven with, for example, the bumps 42.

Moreover, similarly to the case in which the chuck table 16 in the above embodiment is used, by conducting the half-cutting method including the holding process to hold the workpiece 11 against the chuck table 80, the upper-surface height measuring process to measure the height of the upper surface of the workpiece 11 at a plurality of positions along the cut-feeding direction, the cutting process to cut and process the workpiece 11 with the cutter blades 38 lifted or lowered based on the measured heights of the upper surface, and, even when the workpiece 11 with warps is held on the chuck table 80, cut-processing to form the cut grooves 39 with the predetermined depth may be accurately performed with the workpiece 11.

As may be recognized from the embodiment above and the modified example, a material or composition of the elastic member (70, 82) to be located entirely over the holder surface of the chuck table (16, 80) may not necessarily be limited as long as the elastic member may closely conform with the warped form of the workpiece and fit tightly to the entire lower surface of the workpiece.

As described above, the chuck table 16, 80 is provided with the elastic member 70, 82 made of the elastomer with the predetermined thickness located entirely over the holder surface of the base 51 and may suction and hold the entire lower surface of the warped workpiece 11 thereby. Rather than straightening and flattening the warpage in the workpiece 11, the elastic member 70, 82 to conform with and fit to the form of the lower surface of the workpiece 11 is provided; therefore, without a complicated mechanism or strong suctioning force to straightening the warpage of the workpiece 11, the workpiece 11 remaining warped may be stably held on the chuck table 16, 80.

The chuck table 16, 80 is provided with the lower seat 50 and the base 51 with preferable rigidity, and the elastic member 70, 82 is arranged merely on top of the base 51; therefore, compared to a chuck table formed entirely of an elastic member alone, the chuck table 16, 80 has higher rigidity and may exhibit the ability to fit tightly to the entire lower surface of the workpiece 11 and suction and hold the workpiece 11. In other words, both stability to hold the workpiece 11 and conformability with the form of the lower surface of the workpiece 11 may be achieved at highly satisfactory levels.

Moreover, according to the half-cutting method including the holding process, the upper-surface height measuring process, and the cutting process, the workpiece 11 held on the chuck table 16, 80 in the warped condition may be processed by being cut into the depth, where the influence of the warping is corrected. Therefore, the cut grooves having the predetermined depth may be formed with the preferable processing accuracy.

The package substrate in the rectangular form such as the workpiece 11 in the above embodiment is a processing material that may often warp or separate above from the chuck table easily; therefore, the chuck table according to the present disclosure is highly useful. However, the plate-shaped workpiece to be held on the holder surface of the chuck table may not necessarily be limited to the package substrate in the rectangular form. For example, the present disclosure may be applied to a chuck table for holding a disc-shaped wafer.

Moreover, while the chuck table according to the present disclosure is advantageous in the cutting apparatus in the above embodiment, the chuck table may be applied to a processing apparatus other than the cutting apparatus. As a processing apparatus that may suction and hold a plate-shaped workpiece with the chuck table, other than the cutting apparatus, for example, a laser processing apparatus, a griding apparatus, and a polishing apparatus are known, and the chuck table according to the present disclosure may be used to hold a warped workpiece in these apparatuses.

Embodiment of the present disclosure may not necessarily be limited to the configuration described above and in the modified example but may be modified, substituted, or altered in various ways without departing from the spirit of the technical idea of the present disclosure. Furthermore, if the technical idea of the present disclosure may be realized in a different way due to technological progress or other derived technology, it may be implemented with use of the method. Therefore, the claims cover all embodiments that may be included within the scope of the technical idea of the present disclosure.

As described above, according to the chuck table of the present disclosure, a lower surface of a workpiece may be entirely suctioned and held against the chuck table. Therefore, a processing quality of the workpiece held on the chuck table may be improved, and damage to processing tools such as cutter blades may be prevented. Furthermore, according to the half-cutting method of the present disclosure, cut grooves, of which depth is smaller than a depth of the workpiece, may be formed in the warped workpiece accurately, and the processing quality to cut the workpiece may be improved.

What is claimed is:

1. A chuck table configured to suction and hold a plate-shaped workpiece on a holder surface, the chuck table comprising:
a base having a holder surface region on an upper surface thereof;
a plurality of suction holes arranged in the holder surface region and formed through to a lower surface of the base, the plurality of suction holes being connectable with a suction source; and
an elastic member made of an elastomer having a predetermined thickness, the elastic member being arranged entirely in the holder surface region and forming the holder surface.

2. The chuck table according to claim 1, wherein a dynamic viscoelasticity of the elastic member when a temperature is between 20° C. and 30° C. is greater than or equal to 0.1 tan δ and smaller than or equal to 0.4 tan δ.

3. The chuck table according to claim 1, wherein the elastic member is formed of a thermoplastic elastomer.

4. The chuck table according to claim 1, wherein the elastic member is formed of a foam elastomer.

5. The chuck table according to claim 1, wherein the plate-shaped workpiece has bumps on a surface on one side thereof and is held by the chuck table with the bumps being in contact with the elastic member.

6. A half-cutting method for forming a cut groove having a predetermined depth smaller than a thickness of the plate-shaped workpiece, in the plate-shaped workpiece held by the chuck table according to claim 1 with a cutter blade, the method comprising:
a holding process for causing the chuck table to suction and hold the plate-shaped workpiece thereon;
an upper-surface height measuring process for moving the plate-shaped workpiece held in the holding process in a cut-feeding direction and measuring heights of an upper surface of the plate-shaped workpiece at a plurality of positions along the cut-feeding direction with respect to the cutter blade; and
a cutting process for forming the cut groove having the predetermined depth from the upper surface of the plate-shaped workpiece by moving the plate-shaped workpiece in the cut-feeding direction and lifting or lowering the cutter blade based on the heights of the upper surface measured in the upper-surface height measuring process.
